(19) United States
(12) Patent Application Publication
(10) Pub. No.: US 2025/0215204 A1
(43) Pub. Date: Jul. 3, 2025

(54) Controlled Molecular Weight Distribution of Isobutylene-Co-Paramethylstyrene Elastomer Compositions and Methods Related Thereto

(71) Applicant: ExxonMobil Technology and Engineering Company, Baytown, TX (US)

(72) Inventors: Sunny Jacob, Seabrook, TX (US); Zaccheus M. Mokua, Katy, TX (US); Caol P. Huff, Houston, TX (US)

(21) Appl. No.: 19/112,653

(22) PCT Filed: Sep. 1, 2023
(86) PCT No.: PCT/US2023/073297

§ 371 Date: Mar. 18, 2025

Related U.S. Application Data
(60) Provisional application No. 63/405,926, filed on Sep. 13, 2022.

(51) Int. Cl. C08L 23/22; C08L 23/283

(52) U.S. Cl. CPC C08L 23/22; C08L 23/283; C08L 2205/025

(57) ABSTRACT

Methods for controlling molecular weight distribution of elastomer compositions and, in particular, an isobutylene-co-paramethylstyrene elastomer compositions, particularly for use in tire compositions such as innerliners. At least first and second isobutyl-co-paramethylstyrene compositions are blended together and the blended isobutyl-co-paramethylstyrene compositions have a blended molecular weight distribution of equal to or greater than about 2.5.

### CROSS-REFERENCE TO RELATED APPLICATION

This application claims priority to and the benefit of U.S. Provisional Patent Application 63/405,926, filed 13 Sep. 2022, entitled CONTROLLED MOLECULAR WEIGHT DISTRIBUTION OF ISOBUTYLENE-CO-PARAMETHYLSTYRENE ELASTOMER COMPOSITIONS AND METHODS RELATED THERETO, the disclosure of which is incorporated herein by reference in its entirety.

### FIELD OF INVENTION

This application relates to methods for controlling molecular weight distribution of elastomer compositions and, in particular, for broadening the molecular weight distribution of isobutylene-co-paramethylstyrene elastomer compositions.

### BACKGROUND

Tires contain many rubber compounds and other materials required to safely perform in a wide range of demanding conditions for passenger, truck, bus, and aircraft vehicles, for example. They are expected to perform over many thousands of miles while retaining their essential performance and safety properties. Tire performance is at least partially dependent upon their ability to retain air or inflation pressure. Butyl rubbers, such as isobutylene-co-paramethylstyrene elastomers, are particularly suitable for air retention and can be formulated for specific tire applications, such as innerliners, the innermost layer of a tire. A particular butyl rubber composition, including additional additives, for use as an innerliner is selected in order to achieve suitable characteristics related to, among other things, processability and uncured v. cured physical properties, which include mechanical strength, surface appearance, and splice integrity. A number of factors can influence these properties.

Molecular weight distribution (MWD=Mw/Mn), also called polydispersity index, has a significant effect on the mechanical and physical bulk properties of polymers and resultant compounded products, including those that are integral for manufacturing commercially viable tire innerliners-processability and uncured v. cured physical properties. For innerliner applications, the butyl rubber compound Mooney viscosity and Mooney relaxation are important for producing rubbers with innerliner splicing characteristics that result in suitable splice strength integrity after curing. A balance of the MWD of butyl rubber (high v. low molecular weight butyl rubber) is needed to achieve these properties while maintaining processability; high molecular weight fractions contribute to mechanical properties, such as tensile break, elongation, impact strength, and the like, whereas low molecular weight fractions contribute to processability factors, such as low melt viscosity, plasticizer quality, and the like. Accordingly, a broad MWD of butyl rubber is of significance for the production of commercially viable tire innerliners and, ultimately, final tire products.

Butyl rubber polymerization is conventionally carried out using an appropriate monomer and Lewis acid catalyst (and initiator). However, widespread inconsistency in MWD of butyl rubbers throughout the tire industry have been previously documented. It has further been observed that innerliner tire products currently produced typically show narrow MWDs. As described above, narrow MWD can lead to processing difficulties and/or undesirable physical and mechanical properties.

The present disclosure provides methods and systems for producing isobutylene-co-paramethylstyrene elastomer compositions having controlled MWDs, particularly isobutylene-co-paramethylstyrene elastomer compositions having comparatively broadened MWDs.

### SUMMARY

In nonlimiting aspects of the present disclosure, a method is provided including blending at least a first isobutylene-co-paramethylstyrene composition and a second isobutylene-co-paramethylstyrene composition, thereby producing a blended isobutylene-co-paramethylstyrene composition. The blended isobutylene-co-paramethylstyrene composition has a blended molecular weight distribution of equal to or greater than about 2.5.

In nonlimiting aspects of the present disclosure, a method is provided including polymerizing a first polymerization medium in a reactor, the first polymerization medium comprising first monomers of isobutylene, first monomers of paramethylstyrene, a first diluent, and a first catalyst system, wherein the first catalyst system comprises a first Lewis acid and a first initiator, thereby producing a first isobutylene-co-paramethylstyrene composition; and polymerizing a second polymerization medium in a reactor, the second polymerization medium comprising second monomers of isobutylene, second monomers of paramethylstyrene, a second diluent, and a second catalyst system, wherein the second catalyst system comprising a second Lewis acid and a second initiator, thereby producing a second isobutylene-co-paramethylstyrene composition. The first isobutylene-co-paramethylstyrene composition and the second isobutylene-co-paramethylstyrene composition are blended, thereby producing a blended isobutylene-co-paramethylstyrene composition and the blended isobutylene-co-paramethylstyrene composition has a blended molecular weight distribution of equal to or greater than about 2.5.

These and other features and attributes of the disclosed controlled MWD methods and systems for producing isobutylene-co-paramethylstyrene elastomer compositions of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a schematic flow diagram of a simplified polymerization system 100, according to one or more aspects of the present disclosure

FIG. 2 is a schematic of a bromination reaction for isobutylene-co-paramethylstyrene, according to one or more aspects of the present disclosure.

FIGS. 3 and 4 are blending schemes for producing blended isobutylene-co-paramethylstyrene polymers, according to one or more aspects of the present disclosure.

FIG. 5 is a chart displaying MWD for control and blended isobutylene-co-paramethylstyrene polymers, according to one or more aspects of the present disclosure.

FIG. 6 is a chart displaying MWD for control and blended isobutylene-co-paramethylstyrene polymers, according to one or more aspects of the present disclosure.

### DETAILED DESCRIPTION

This application relates to methods for controlling molecular weight distribution of elastomer compositions and, in particular, for broadening the molecular weight distribution of isobutylene-co-methylstyrene elastomer compositions.

The present disclosure provides a methodology for controlling the MWD of isobutylene-co-paramethylstyrene elastomer compositions by blending two or more polymers. In particular, the present disclosure provides controlled MWD broadening by blending two or more isobutylene-co-paramethylstyrene polymers in particular ratios to obtain defined molecular weight and MWD. In one or more aspects, the resultant broadened isobutylene-co-paramethylstyrene compositions may be further functionalized, such as by halogenation (e.g., bromination).

In various aspects of the present disclosure, individual isobutylene-co-paramethylstyrene polymers are prepared in separate polymerization reactors and blended in a finishing step, such as within a mixing drum. One or more of the individual isobutylene-co-paramethylstyrene polymers may be brominated before blending. Each of the individual isobutylene-co-paramethylstyrene polymer compositions have known MWD, as well as known other characteristics, such as Mooney viscosity. In one or more alternative aspects of the present disclosure, the individual isobutylene-co-paramethylstyrene polymer may be polymerized in a series of two or more reactors. For example, polymerization may begin in a first reactor and, at a predetermined time, the resultant partial polymerized medium fed into a second reactor for continued polymerization, to grow the polymer chain, and then optionally followed with bromination once a desired MWD is achieved.

The resultant blended isobutylene-co-paramethylstyrene polymer compositions of the present disclosure may have any desired MWD, but preferably a broadened MWD of equal to or greater than about 2.5.

### Definitions

As used herein, the term “catalyst system,” and grammatical variants thereof, refers to and includes any Lewis acid(s) or other metal complex(es) used to catalyze the polymerization of hydrocarbon monomers and an optional at least one initiator. Other additives may be included, such as catalyst modifiers, for example. The catalyst system is combined with a diluent for polymerization, collectively termed a “polymerization medium.” A “polymerization system,” as used herein, and grammatical variants thereof, refers to the use of a polymerization medium to produce polymers.

As used herein, the term “diluent,” and grammatical variants thereof, refers to a dilution or dissolving agent, including mixtures thereof (e.g., two or more individual diluents). The diluent may further be used to impact reactor mixing as it serves as a dilution agent.

As used herein, the term “solvent,” and grammatical variants thereof, refers to a chemical agent that can dissolve resultant polymers.

A “reactor,” and grammatical variants thereof, as used herein, refers to any container(s) in which a chemical reaction occurs, such as polymerization. Examples of a butyl polymerization reactor includes a continuous flow-stirred tank reactor which utilizes continuous tank agitation, as well as a draft tube type reactor. Various cooling jackets, tubing, and the like, may be used in combination (and may be integral) with the reactor to control or otherwise maintain the reactor temperature during polymerization. Commercial reactors typically can be well mixed vessels of greater than 10 to 500 liters in volume (excluding jacket) with a high circulation rate provided by a pump impeller. The polymerization and a pump can both generate heat and, in order to keep the slurry cold, the reaction system can include heat exchangers. In some reactors, slurry can circulate through tubes of a heat exchanger. Cooling can be provided, for example, by boiling ethylene on a shell side. Slurry temperature can be set by the boiling ethylene temperature, the required heat flux and the overall resistance to heat transfer.

As used herein, the term “slurry,” and grammatical variants thereof, refers to an amount of diluent comprising polymer that has precipitated from a catalyst system and diluent. The slurry concentration is the weight percent of the partially or completely precipitated polymers based on the total of the slurry.

As used herein, the term “quench,” and grammatical variants thereof, refers to a process of rapidly heating and mixing a reactor effluent stream with a quench medium, wherein further polymerization is terminated.

The term “polymer,” and grammatical variants thereof, as used herein refers to homopolymers, copolymers, interpolymers, terpolymers, etc. The term “copolymer,” and grammatical variants thereof, is meant to include polymers having two or more monomers. The term “interpolymer,” and grammatical variants thereof, means any polymer or oligomer having a number average molecular weight of 500 or more prepared by the polymerization or oligomerization of at least two different monomers. As used herein, when a polymer is referred to as “comprising” a monomer, the monomer is present in the polymer in the polymerized form of the monomer or in the derivative form of the monomer.

The term “functionalization,” and grammatical variants thereof, refers to a polymer to which functional groups are chemically bound. The term “functional group,” and grammatical variants thereof, may refer to halides, activated esters, anhydrides, thiols, ketones, epoxides, and the like. Of particular interest for the present disclosure is halide, or halogen, functionalization.

As used herein, the term “olefin,” and grammatical variants thereof, refers to a hydrocarbon containing a carbon-carbon double bond. An “isoolefin,” and grammatical variants thereof, refers to any olefin monomer having two substitutions on the same carbon.

“Elastomer” or “elastomeric composition,” as used herein, and grammatical variants thereof, refers to any polymer or composition of polymers consistent with the ASTM D1566 definition, Revision 21A (November 2021). Elastomer may be used herein interchangeably with the term “rubber(s).”

“Mooney viscosity,” as used herein, and grammatical variants thereof, is the Mooney viscosity of a polymer or polymer composition. The polymer composition analyzed for determining Mooney viscosity should be substantially devoid of diluent. For instance, the sample may be placed on a boiling-water steam table in a hood to evaporate a large fraction of the diluent and unreacted monomers, and then, dried in a vacuum oven overnight (12 hours, 90° C.) prior to testing, in accordance with laboratory analysis techniques, or the sample for testing may be taken from a devolatilized polymer (i.e., the polymer post-devolatilization in industrial-scale processes). Unless otherwise indicated, Mooney viscosity is measured using a Mooney viscometer according to ASTM D1646-19A (November 2019), but with the following modifications/clarifications of that procedure. First, sample polymer is pressed between two hot plates of a compression press prior to testing. The plate temperature is 125° C.+/−10° C. instead of the 50+/−5° C. as recommended in ASTM D1646-17, because 50° C. is unable to cause sufficient massing. Further, although ASTM D1646-17 allows for several options for die protection, should any two options provide conflicting results, PET 36 micron is used as the die protection. Further, ASTM D1646-17 does not indicate a sample weight in Section 8; thus, to the extent results may vary based upon sample weight, Mooney viscosity determined using a sample weight of 21.5+/−2.7 grams (g) per D1646-17 Section 8 procedures will govern. Finally, the rest procedures before testing set forth in D1646-17 Section 8 are 23+/−3° C. for 30 min in air; Mooney values as reported herein were determined after resting at 24+/−3° C. for 30 min in air. Samples are placed on either side of a rotor according to the ASTM D1646-17 test method; torque required to turn the viscometer motor at 2 rpm is measured by a transducer for determining the Mooney viscosity. The results are reported as Mooney Units (ML, 1+4 @ 125° C. or ML, 1+8 @ 125° C.), where MU is the Mooney viscosity number, L denotes large rotor (defined as ML in ASTM D1646-17), 1 is the pre-heat time in minutes, 4 or 8 is the sample run time in minutes after the motor starts, and 125° C. is the test temperature. Thus, a Mooney viscosity of 90 determined by the aforementioned method would be reported as a Mooney viscosity of 90 MU (ML, 1+8 @ 125° C.) or 90 MU (ML, 1+4 @ 125° C.). Alternatively, the Mooney viscosity may be reported as 90 MU; in such instance, it should be assumed that the just-described (ML, 1+4 @ 125° C.) method is used to determine such viscosity, unless otherwise noted. In some instances, a lower test temperature may be used (e.g., 100° C.), in which case Mooney is reported as Mooney Viscosity (ML, 1+8 @ 100° C.), or @ T° C. where T is the test temperature.

As used herein, the term “Mooney relaxation” or “Mooney stress relaxation,” and grammatical variants thereof, refers to the response of an elastomer (e.g., an isobutylene-co-paramethylstyrene) to a rapid cessation of flow or a sudden deformation, and is dependent upon Mooney viscosity. Mooney relaxation is determined according to ASTM D1646-17.

Numerical ranges used herein include the numbers recited in the range. For example, the numerical range “from 1 wt % to 10 wt %” includes 1 wt % and 10 wt % within the recited range.

### Polymerization System

The present disclosure provides methods for controlling MWD using post-polymerization blending of two or more isobutylene-co-paramethylstyrene copolymer (hereinafter simply “polymer”) compositions having known MWDs to achieve a desired MWD. In one or more aspects described herein, the present disclosure provides blending methodologies to broaden the MWD compared to traditional isobutylene-co-paramethylstyrene polymers to achieve improved processability, such as for the manufacture of tire innerliners. In one or more aspects, the resultant blended isobutylene-co-paramethylstyrene polymer compositions have an MWD of equal to or greater than about (referred to hereinafter simply as “about”) 2.5, including in the range of about 2.5 to about 5.0, encompassing any value and subset therebetween, such as about 2.5 to about 3.5, or about 3.5 to about 4.5, or about 4.5 to about 5.0, or about 2.5 to about 3.0, or 2.6 to 3.75.

Before describing the methodologies of the present disclosure in further detail, a brief overview of an example generalized polymerization system for producing isobutylene-co-paramethylstyrene elastomers is provided such that the various aspects of the present disclosure may be better understood, including the additional blending configurations that will be described and depicted herein.

Polymerization systems for producing isobutylene-based elastomers, such as isobutylene-co-paramethylstyrene elastomers, are typically carried out using a continuous slurry polymerization system, with a polymerization reactor temperature of less than 0° C., such as in the range of about −105° C. to about 0° C. It is to be appreciated, however, that a batch or reactor series polymerization system may be used in accordance with one or more aspects described herein, without departing from the scope of the present disclosure.

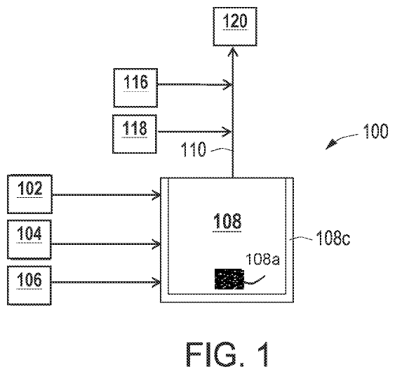

Referring now to FIG. 1, illustrated is a schematic flow diagram of a polymerization system 100, according to one or more aspects of the present disclosure. Catalyst system 102 and monomers 104 are fed into polymerization reactor 108. In some instances, the catalyst system 102 and monomers 104 may be blended in a blend unit (not shown) prior to being fed to the polymerization reactor 108. Further, in some instances, prior to introducing the monomers 104 into the polymerization reactor 108 (or blend unit), they may be treated to remove impurities, if necessary. For the production of isobutylene-co-paramethylstyrene, the monomers 104 include C₄-C₇ isoolefin isobutylene (hereinafter simply “isobutylene”) and paramethylstyrene (hereinafter “p-methylstyrene”).

The catalyst system 102 and monomers 104 may be fed into the polymerization reactor 108 simultaneously or separately, such as by one or more pump impellers (not shown). The monomers 104, alone or in combination with the catalyst system 102, are fed into the polymerization reactor 108 at a temperature less than 0° C. The catalyst system 102, including the components of the catalyst system 102 (e.g., Lewis acid(s) and initiator(s)), and monomers 104 are mixed within the polymerization reactor 108 and may exist initially as a single phase dissolved in a diluent 106, also fed simultaneously or separately. The diluent 106 serves to dissolve the catalyst system 102 and monomers 104, without dissolving polymerization product (polymers) and, thus, allowing them to precipitate and form a slurry. When one or more of the inputs are simultaneously fed into the polymerization reactor 108, a single pump impeller may be used. The one or more pump impellers are typically capable of one or both of up-pumping or down-pumping (i.e., bi-directional pumping) and often include an electric motor with measurable amperage. The pump impeller serves to keep a constant flow of monomers, catalyst system, and diluent, including reacted and non-reacted species (e.g., monomers) within the reactor.

The polymerization reactor 108 may be any suitable reactor for polymerization to produce isobutylene-based elastomers. In one or more aspects, the polymerization reactor 108 is a continuous daft tube reactor with a circulating pump 108a for efficient agitation located within overflow piping. Typically, the polymerization reactor 108 is equipped with an external cooling jacket 108c and associated internal cooling (or heat-exchange) tubes to remove heat produced during polymerization and maintain desired reaction temperatures. In one or more aspects, the cooling tubes may include liquid ethylene to draw heat away from the polymerization reaction.

In one or more aspects, the polymerization reactor may have a volume, including the jacket and associated internal cooling tubes, in the range of about 425 liters (L) to about 500 L, encompassing any value and subset therebetween, and if the jacket is excluded may be about 50 L larger. Said volume is conducive for large scale volume polymerization reactions in accordance with the various aspects described herein. Accordingly, the reactors having larger volumes (and smaller volumes, though less preferred) may be utilized to facilitate up-scaling, without departing from the scope of the present disclosure.

Generally, the polymerization temperature within the polymerization reactor 108 for producing isobutylene-based elastomers of the present disclosure is in the range of about −105° C. to about 0° C., or −100° C. to −50° C., or −98° C. to −92° C., and the like, preferably from 0° C. to the freezing point of the polymerization medium, such as the diluent and monomer mixture and then quenching the reaction by the addition of a quench agent in the polymerization medium.

During polymerization, the catalyst system 102 and monomers 104 react and the resultant polymers precipitate from the diluent 106. Reactor effluent stream 110 comprising polymers (produced during polymerization), diluent 106, unreacted monomers 104, and unreacted catalyst system 102 exits the reactor from a reactor outlet. For isobutylene-based elastomer polymerization system 100, the reactor effluent stream 110 may be warmed to room temperature (RT) or otherwise heated, such as from the at or below 0° C. temperatures (within the polymerization reactor 108) to temperatures in the range of, for example, about −50° C. to about 20° C., encompassing any value and subset therebetween.

Unreacted catalyst system 102 within the reactor effluent stream 110 may form undesirable species that interfere with downstream processing of the polymers produced during polymerization, such as functionalization thereof. During the warming or heating, but prior to heating above about −50° C. to about 20° C. the reactor effluent stream 110, may be quenched 118. Quenching serves to terminate the reactive capability of all unreacted catalyst system 102 (that is, the catalyst(s) within the catalyst system 102) prior to any significant warming or heating of the reactor effluent stream 110 in order to prevent continued polymerization and crosslinking reactions from occurring as the reactor effluent stream 110 is heated, which may interfere with downstream processing. Traditional quenching agents include steam and/or hot water introduced to the reactor effluent stream 110. Other traditional quenching agents include alcohols, linear or branched, such as ethanol, tert-butanol, methanol, triethylene glycol (TEG), and any combination thereof. During quenching, the reactor effluent stream 110 may be combined with solvent 116 in order to dissolve and fractionate desired polymers in reactor effluent stream 110 for downstream processing 120 (e.g., halogenation, and further blending with other polymer streams) (e.g., for forming the isobutylene-co-paramethylstyrene polymer compositions having desired MWD according to the present disclosure) from diluent(s) 106, solvent(s) 116, and any unreacted monomers 104 or diluent or solvent to a tank or other storage container (not shown). The contents within tank may be recycled in one or more aspects of the present disclosure.

### Polymerization System for Controlling the MWD (and MRI) of Isobutylene-Co-Paramethylstyrene Elastomers

The methodology of the present disclosure for producing isobutylene-co-paramethylstyrene elastomer compositions having controlled MWD generally utilizes existing polymerization systems, such as that described with reference to FIG. 1, but employs unconventional post-polymerization blending of two or more isobutylene-co-paramethylstyrene elastomer compositions. These blending processes advantageously can be used to broaden the MWD of a resultant isobutylene-co-paramethylstyrene elastomer product. While the present disclosure is described with reference to tire innerliners having a desirable broad MWD of isobutylene-co-paramethylstyrene elastomer, it is to be appreciated that the present disclosure may be applicable to other types of air retention products or may be applicable to other rubber products that have a desirable broad MWD. That is, the various aspects of the present disclosure may be used to control MWD generally for isobutylene-co-paramethylstyrene elastomers, without departing from the scope of the present disclosure. Moreover, the various aspects described herein can encompass blending of any isobutylene-based elastomers to achieve desired broadened MWD, not merely isobutylene-co-paramethylstyrene, without departing from the scope of the present disclosure.

In one or more aspects, the present disclosure provides a polymerization system for polymerizing a polymerization medium, the polymerization medium comprising monomers isobutylene and p-methylstyrene, a diluent, and a catalyst system, thereby forming an isobutylene-co-paramethylstyrene polymer composition. Two or more such isobutylene-co-paramethylstyrene polymer compositions are thereafter blended in a particular ratio to achieve a desired broadened MWD. In optional aspects, one or more of such isobutylene-co-paramethylstyrene polymer compositions may be brominated, or otherwise halogenated, prior to blending.

For use in preparing the isobutylene-co-paramethylstyrene compositions of the present disclosure for blending, the monomers for polymerization include isobutylene and p-methylstyrene. The isobutylene and p-methylstyrene may be present in equal or unequal amounts, without departing from the scope of the present disclosure.

In one or more aspects, the monomers (in total) may be present in a polymerization medium in an amount ranging from about 30 weight percent (wt %) to about 40 wt %, such as about 30 wt % to about 35 wt %, or about 35 wt % to about 40 wt %, encompassing any value and subset therebetween.

In one or more aspects of the present disclosure, the resultant isobutylene-co-paramethylstyrene polymers comprise about 80 mole percent (mol %) to about 99.5 mol % of isobutylene, encompassing any value and subset therebetween, such as about 80 mol % to about 90 mol %, or about 90 mol % to about 99.5 mol % of isobutylene; and comprise 0.5 mol % to about 20 mol % of p-methylstyrene, encompassing any value and subset therebetween, such as about 0.5 mol % to about 5 mol %, or about 0.5 mol % to about 10 mol %, or about 5 mol % to about 10 mol %, or about 10 mol % to about 20%.

The diluent or solvent is selected, or mixtures thereof, to dissolve the catalyst in the catalyst system and the monomer(s) and allow precipitation of polymerization product (polymers)-isobutylene-co-paramethylstyrene. An acceptable relatively low viscosity of the polymerization medium is obtained enabling the heat of polymerization to be removed more effectively by surface heat exchange. Suitable solvents include organic compounds, particularly those with an affinity for hydrocarbon fluids. Examples of suitable solvents for use in the present disclosure include, but are not limited to, hydrocarbons, such as hexanes, heptanes, halogenated hydrocarbons, such as chlorinated hydrocarbons, such as ethyl chloride, methyl chloride, CHCl₃, CCl₄, n-butyl chloride, chlorobenzene, and the like, and any combination thereof. In one or more aspects of the present disclosure, the selected solvent is methyl chloride, methyl dichloride, or hexane. Methyl chloride, for example, is a commercially acceptable solvent due to its suitable freezing and boing points.

According to one or more aspects of the present disclosure, a solvent, such as methyl chloride or hexane, is selected for use in the polymerization systems described herein for controlling molecular weight and advantageously can achieve an isobutylene-co-paramethylstyrene elastomer polymerization product concentration in the range of about 20 volume percent (vol %) to about 60 vol %, encompassing any value and subset therebetween, such as about 20 vol % to about 50 vol %, or about 30 vol % to about 35 vol %, or about 18 vol % to about 28 vol %, or about 24 vol % to about 27 vol %. Among other factors, the amount of solvent may be adjusted according to one or more aspects of the present disclosure to adjust viscosity of the polymerization medium.

The catalyst systems of the present disclosure include a Lewis acid(s) or metal complex(es) and an initiator. The Lewis acid(s) or metal complex(es) are allowed to contact one another for a period of time prior to introduction of the monomer(s), in one or more aspects, for at least a plurality of hours, such as in the range of about 0.5 seconds to about five hours, or about 0.5 seconds to about 2 hours, or about 0.5 seconds to about 30 minutes, encompassing any value and subset therebetween. In some aspects, the contact time between the Lewis acid(s) or metal complex(es) and initiator is in the range of between about 0.5 seconds to about 5 minutes, or about 1 second to about 5 minutes, encompassing any value and subset therebetween. In yet other aspects, the Lewis acid(s) or metal complex(es) and initiator may be fed into a reactor separately, thus having no predetermined contact time.

The Lewis acid(s) or metal complex(es) are intended to catalyze polymerization to produce isobutylene-co-paramethylstyrene elastomers. Aluminum-based Lewis acids may be used in various aspects of the present disclosure. Suitable examples of aluminum-based Lewis acids include, but are not limited to, aluminum trichloride, aluminum tribromide, ethyl aluminum dichloride (EADC), ethyl aluminum sesquichloride, diethyl aluminum chloride, methyl aluminum dichloride, methyl aluminum sesquichloride, dimethyl aluminum chloride, and the like, and any combination thereof alone or with other suitable Lewis acids. Other suitable examples include boron-based Lewis acids, such as boron trifluoride, and titanium-based Lewis acids, such as titanium tetrachloride, and the like, and any combinations thereof alone or with other suitable Lewis acids. In exemplary aspects of the present disclosure, the selected Lewis acid(s) include aluminum-based Lewis acids.

In one or more aspects, the Lewis acid(s) and initiator may be present in the polymerization systems described herein in a molar ratio in the range of about 1.0 to about 10.0 (Lewis acid(s) to initiator), encompassing any value and subset therebetween, such as about 1.0 to about 2.5, or about 2.5 to about 5.0, or about 5.0 to about 7.5, or about 7.5 to about 10.0. Such ratio is equally applicable to any other Lewis acid(s) or metal complex(es) to initiators, as described herein, without departing from the scope of the present disclosure.

Various initiators may be used in the polymerization systems of the present disclosure for controlling the MWD of isobutylene-co-paramethylstyrene elastomers, provided that they are compatible with the other components of the polymerization medium. The initiator for use in the present disclosure is selected such that it is capable of being complexed in a suitable diluent with the chosen Lewis acid(s) or other metal complex(es) to yield a complex which rapidly reacts with the isobutylene and p-methylstyrene monomers, thereby forming a propagating polymer chain (polymerization). Suitable examples of initiators for use in the present disclosure include, but are not limited to, Bronsted acids such as H₂O, HCl, RCOOH (wherein R is an alkyl group), alkyl halides, such as (CH₃)₃CCl, C₆H₅C(CH₃)₂Cl, 2-chloro-2,4,4-trimethylpentane, and 2-chloro-2-methylpropane, a hydrogen halide, and any combination thereof. Other suitable initiators may also be used, as would be known by one of skill in the art.

In one or more aspects, the selected initiator(s) is diluted in the diluent (e.g., hexane, methyl chloride) at a concentration within the polymerization slurry (contents of the reactor) of about 1.0 parts per million (ppm) to about 10.0 ppm, encompassing any value and subset therebetween, such as about 1.0 ppm to about 2.5 ppm, or about 2.5 ppm to about 5.0 ppm, or about 5.0 ppm to about 7.5 ppm, or about 7.5 ppm to about 10.0 ppm, and the like. The catalyst system and monomer reactor feed flows, as well as diluent feed flow if separately added, may be adjusted to achieve the desired imitator concentration.

In one or more aspects, after polymerization is complete, the isobutylene-co-paramethylstyrene polymers may be present in an amount of about 22 wt % to about 50 wt % of the remaining polymerization slurry (e.g., diluent, unreacted monomers, unreacted catalyst, unreacted initiator), encompassing any value and subset therebetween, such as about 22 wt % to about 30 wt %, or about 30 wt % to about 40 wt %, or about 40 wt % to about 50 wt %. The particular reactor residence time to achieve the desired isobutylene-co-paramethylstyrene concentration is not particularly limited and is dependent upon a number of factors, such as catalyst activity and concentration, monomer concentrations, feed injection (flow) rate, production rate, reaction temperature, desired molecular weight, and the like. The feed injection rate of the monomers may have the most influence upon residence time. Typically, in aspects of the present disclosure, the reactor residence time is in the range of about 10 minutes (min) to about 60 min, encompassing any value and subset therebetween, such as about 10 min to about 20 min, or about 20 min to about 30 min, or about 30 min to about 40 min, or about 40 min to about 50 min, or about 50 min to about 60 min. Thereafter, as described above, the polymerization slurry exits the reactor and the pump impeller may continue to charge the reactor for continuous polymerization, without departing from the scope of the present disclosure.

The isobutylene-co-paramethylstyrene polymers of the present disclosure have an average molecular distribution of about 2.5, and generally have molecular weight (Mw) in the range of about 200,000 to about 2,000,000 encompassing any value and subset therebetween, such as about 200,000 to about 500,000, or about 500,000 to about 1,000,000, or about 1,000,000 to about 1,500,000, or about 1,500,000 to about 200,000.

Resultant isobutylene-co-paramethylstyrene polymers obtained according to the present disclosure may, in one or more aspects, be halogenated and, in particular, brominated. The polymers may be brominated as described in U.S. Pat. No. 5,162,445, the entirety of which is incorporated herein by reference. Bromination of the isobutylene-co-paramethylstyrene polymers of the present disclosure includes an almost exclusive substitution occurring on the para-methyl group, to yield the desired benzylic bromine functionality. The high specificity of the bromination reaction can be maintained over a broad range of reaction conditions, provided, however, that factors which would promote the counter reaction routes are avoided. Typically the bromination is radical bromination.

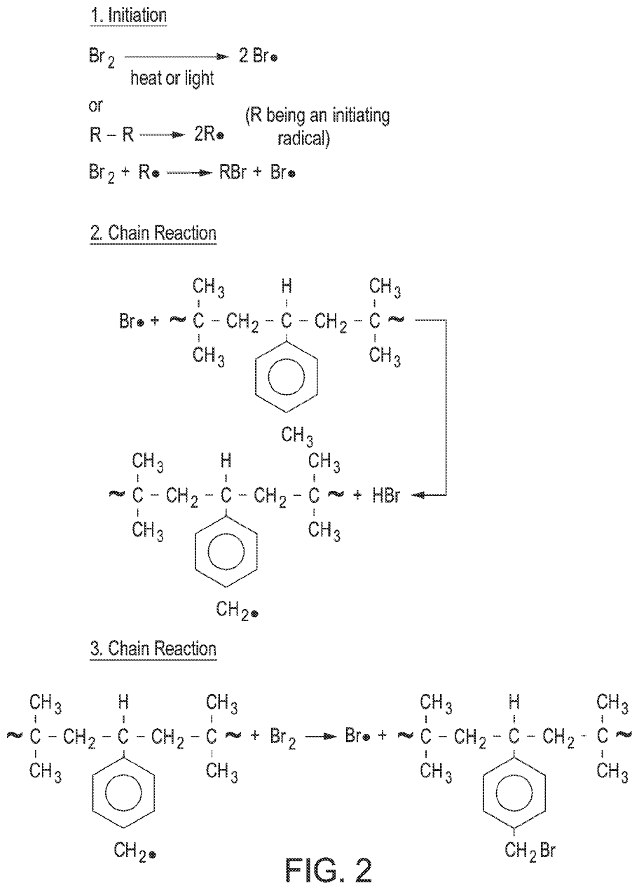

The isobutylene-co-paramethylstyrene polymers described herein are brominated in hydrocarbon solvents, such as pentane, hexane or heptane, using light, heat, or selected radical initiators (according to conditions, i.e., a particular radical initiator must be selected which has an appropriate half-life for the particular temperature conditions being utilized, with generally longer half-lives preferred at warmer hydrogenation temperatures) as promoters of radical halogenation, to yield almost exclusively the desired benzylic bromine functionality, via substitution on the para-methyl group, and without appreciable chain scission and/or crosslinking. Without being bound by any theory, it is believed that the bromination reaction proceeds by means of a rapid radical chain reaction with the chain carrier being, alternatively, a bromine atom and a benzylic radical resulting from hydrogen atom abstraction from a para-methyl group on the enchained paramethylstyrene moiety. The proposed mechanism thus involves the steps shown in FIG. 2. The reaction terminates when one of the radicals reacts with a quenching agent (or is otherwise quenched) in the system, or the radicals destroy themselves by recombination or disproportionation.

Referring to FIG. 2, the reaction can be initiated as shown in step (1) by formation of a bromine atom, either photochemically or thermally (with or without the use of sensitizers), or the radical initiator used can be one which preferentially reacts with a bromine molecule rather than one which reacts indiscriminately with bromine atoms, or with the solvent or polymer (e.g., via hydrogen abstraction). Photochemical sensitizers preferably themselves absorb lower energy photons and disassociate, thus causing, in turn, disassociation of the bromine, including materials such as iodine. In one or more aspects, the radical initiator has a half-life in the range of about 0.5 min to about 2500 min under the desired reaction conditions, encompassing any value and subset therebetween, such as about 0.5 min to 500 min, or about 500 min to about 1000 min, or about 1000 min, to about 1500 min, or about 1500 min to about 2000 min, or about 2000 min to about 25500 min. In some aspects, the radical initiator has a half-life in the range of about 10 min to about 300 min, encompassing any value and subset therebetween.

The amount of radical initiator employed for bromination may be in the range of about 0.02 wt % to about 1.0 wt % of the isobutylene-co-paramethylstyrene polymer, such as about 0.02 wt % to about 0.1 wt %, or about 0.1 wt % to about 0.5 wt %, or about 0.5 wt % to about 1.0 wt %. In some aspects, the amount of radical initiator is in the range of about 0.02 wt % to about 0.3 wt % of the isobutylene-co-paramethylstyrene polymer, encompassing any value and subset therebetween.

Suitable radical initiators include, but are not limited to, bis azo compounds, such as azo bis isobutyronitrile, azo bis (2,4 dimethyl valero) nitrile, azo bis (2 methyl butyro) nitrile, and the like, and any combination thereof. Other radical initiators may also be used, but it is preferred to use a radical initiator which is relatively poor at hydrogen abstraction so that it reacts preferentially with the bromine molecules to form bromine atoms rather than with the isobutylene-co-paramethylstyrene or solvent to form alkyl radicals. In such cases, there would then tend to be resultant a molecular weight loss of the isobutylene-co-paramethylstyrene, and promotion of undesirable side reactions, such as crosslinking. The radical bromination reaction for use in the present disclosure is highly selective, and almost exclusively produces the desired benzylic bromine functionality. Indeed, the only major side reaction which appears to occur is disubstitution at the para-methyl group, to yield the dibromo derivative, but even this does not occur until more than about 60% of the enchained paramethylstyrene moieties have been monosubstituted. Hence, any desired amount of benzylic bromine functionality in the monobromo form can be introduced to the isobutylene-co-paramethylstyrene of the present disclosure, up to about 60 mole % of the paramethylstyrene content. Furthermore, because the paramethylstyrene content can be varied over a generally wide range as described herein, it is possible to additionally introduce a significant functionality range. The brominated isobutylene-co-paramethylstyrene polymers of the present disclosure are accordingly highly useful in subsequent reactions, for example crosslinking reactions, such as for use in forming tire innerliners.

It is desirable that the termination reactions discussed above be minimized during bromination, so that long, rapid radical chain reactions occur, and so that many benzylic bromines are introduced for each initiation, with a minimum of the side reactions resulting from termination. Hence, system purity is important, and steady-state radical concentrations must be kept low enough to avoid extensive recombination and possible crosslinking. The bromination reaction must also be quenched once the bromine is consumed, so that continued radical production with resultant secondary reactions (in the absence of bromine) do not occur or are otherwise minimized. Quenching may be accomplished by cooling, turning off the light source, adding dilute caustic, the addition of a radical trap, and the like, or combinations thereof.

Since one mole of hydrogen bromide (HBr) is produced for each mole of bromine reacted with or substituted on the enchained paramethylstyrene moiety, in one or more aspects it may be desirable to neutralize or otherwise remove the HBr during the reaction, or at least during polymer recovery in order to prevent it from becoming involved in or catalyzing undesirable side reactions. Such neutralization and removal can be accomplished with a post-reaction caustic wash, generally using a molar excess of caustic on the HBr. Alternatively, neutralization can be accomplished by having a particulate base (which is relatively nonreactive with bromine) such as calcium carbonate powder present in dispersed form during the bromination reaction to absorb the HBr as it is produced. Removal of the HBr can also be accomplished by stripping with an inert gas (e.g., N₂), preferably at elevated temperatures.

The brominated, quenched, and neutralized isobutylene-co-paramethylstyrene polymers of described herein are recovered and may be stabilized with appropriate stabilizers (e.g., bistetrazole, calcium stearate, and the like), then further processed to broaden MWD as described herein.

### Methodology for Controlling the MWD of Isobutylene-Co-Paramethylstyrene Elastomers

In one or more aspects herein, a method is provided comprising post-polymerization blending of two or more isobutylene-co-paramethylstyrene polymer compositions, each having a known MWD, to achieve a broadened MWD. Advantageously, it has been found, as provided herein, that a broadened MWD can be achieved compared to either of the individual isobutylene-co-paramethylstyrene polymer compositions alone, or as would be expected by simple combination, which is believed to be attributed at least to differing Mooney viscosities, without being bound by theory. Mooney viscosity can be controlled by controlling the feed ratio of catalyst system to monomers.

In various aspects of the present disclosure, one or more of the isobutylene-co-paramethylstyrene polymer compositions may be brominated, or otherwise halogenated, to improve certain properties of the polymers, such as mechanical or chemical properties.

Broadened MWD is achieved by blending various isobutylene-co-paramethylstyrene polymer compositions in certain ratios in order to achieve an MWD of greater than about 2.5. The resultant broad MWD is particularly conducive for use in forming one or more rubber product parts, such as tire parts, including innerliners. Other applicable end-use rubber products include, but are not limited do, rubber devices (generally air retention), such as inner tubes, tire bladders, tire sidewalls, rubber stoppers (e.g., pharmaceutical stoppers), and the like, and any combination thereof. The blended ratio may depend on a number of factors including, but not limited to, the MWD of each (two or more) individual isobutylene-co-paramethylstyrene polymer composition, the Mooney viscosity of each (two or more) individual isobutylene-co-paramethylstyrene polymer composition, the Mooney relaxation of each (two or more) individual isobutylene-co-paramethylstyrene polymer composition, and any combination thereof. The Mooney viscosity of the individual isobutylene-co-paramethylstyrene polymer compositions may be in the range of about 20 MU to about 70 MU, encompassing any value and subset therebetween, such as about 30 MU to about 40 MU, or about 40 MU to about 50 MU, or about 50 MU to about 60 MU, or about 60 MU to about 70 MU.

The blending described herein may take place after polymerization of individual isobutylene-co-paramethylstyrene polymer compositions in a variety of reactor and mixing configurations as provided herein. Blending of at least two isobutylene-co-paramethylstyrene compositions may be in the range of about 10:90 to about 90:10, encompassing any value and subset therebetween, such as about 10:90 to about 70:30, or about 10:90 to about 50:50, or about 10:90 to about 20:80, or about 20:80 to about 90:10, or about 40:60 to about 60:40.

The methodologies for controlling the MWD of isobutylene-co-paramethylstyrene elastomers are described further hereinbelow with reference to the nonlimiting Examples described herein.

### Example Embodiments

Nonlimiting example embodiments of the present disclosure include:

Embodiment A: A method comprising: blending at least a first isobutylene-co-paramethylstyrene composition and a second isobutylene-co-paramethylstyrene composition, thereby producing a blended isobutylene-co-paramethylstyrene composition, wherein the blended isobutylene-co-paramethylstyrene composition has a blended molecular weight distribution of equal to or greater than about 2.5.

Embodiment B: A method comprising: polymerizing a first polymerization medium in a reactor, the first polymerization medium comprising first monomers of isobuylene, first monomers of paramethylstyrene, a first diluent, and a first catalyst system, wherein the first catalyst system comprises a first Lewis acid and a first initiator, thereby producing a first isobutylene-co-paramethylstyrene composition, polymerizing a second polymerization medium in a reactor, the second polymerization medium comprising second monomers of isobuylene, second monomers of paramethylstyrene, a second diluent, and a second catalyst system, wherein the second catalyst system comprising a second Lewis acid and a second initiator, thereby producing a second isobutylene-co-paramethylstyrene composition, blending the first isobutylene-co-paramethylstyrene composition and the second isobutylene-co-paramethylstyrene composition, thereby producing a blended isobutylene-co-paramethylstyrene composition, wherein the blended isobutylene-co-paramethylstyrene composition has a blended molecular weight distribution of equal to or greater than about 2.5.

Embodiment C: A method comprising: polymerizing a first polymerization medium in a first reactor, the first polymerization medium comprising first monomers of isobuylene, first monomers of paramethylstyrene, a first diluent, and a first catalyst system, wherein the first catalyst system comprises a first Lewis acid and a first initiator, thereby producing a first isobutylene-co-paramethylstyrene composition; polymerizing a second polymerization medium in a second reactor, the second polymerization medium comprising second monomers of isobuylene, second monomers of paramethylstyrene, a second diluent, and a second catalyst system, wherein the second catalyst system comprising a second Lewis acid and a second initiator, thereby producing a second isobutylene-co-paramethylstyrene composition; wherein the first reactor and the second reactor are separate, and the polymerizing the first polymerization medium and polymerizing the second polymerization medium is performed in separately in parallel; and blending the first isobutylene-co-paramethylstyrene composition and the second isobutylene-co-paramethylstyrene composition, thereby producing a blended isobutylene-co-paramethylstyrene composition, wherein the blended isobutylene-co-paramethylstyrene composition has a blended molecular weight distribution of equal to or greater than about 2.5.

Nonlimiting example embodiment A may include one or more of the following elements:

Element A1: Wherein the blended molecular weight distribution of the blended isobutylene-co-paramethylstyrene composition is in the range of about 2.5 to about 5.0.

Element A2: Wherein the blended molecular weight distribution of the blended isobutylene-co-paramethylstyrene composition is in the range of 2.6 to 3.75.

Element A3: Wherein the first isobutylene-co-paramethylstyrene composition has a first molecular weight distribution and the second isobutylene-co-paramethylstyrene composition has a second molecular weight distribution, and wherein one or both of the first molecular weight distribution and the second molecular weight distribution are less that the blended molecular weight distribution.

Element A4: Wherein the first isobutylene-co-paramethylstyrene composition has a first molecular weight distribution and the second isobutylene-co-paramethylstyrene composition has a second molecular weight distribution, and wherein one or both of the first molecular weight distribution and the second molecular weight distribution are less than the blended molecular weight distribution, and wherein the first molecular weight distribution and the second molecular weight distribution are the same or different.

Element A5: Wherein a ratio of the first isobutylene-co-paramethylstyrene composition to the second isobutylene-co-paramethylstyrene composition to produce the blended isobutylene-co-paramethylstyrene composition is in the range of 10:90 to 90:10.

Element A6: Further comprising halogenating the blended isobutylene-co-paramethylstyrene composition.

Element A7: Further comprising halogenating the blended isobutylene-co-paramethylstyrene composition, and wherein the halogenating is a radical halogenating process.

Element A8: Further comprising halogenating the isobutylene-co-paramethylstyrene composition, and wherein the halogenating comprises brominating.

Element A9: Wherein the blended isobutylene-co-paramethylstyrene composition comprises an isobutylene content in the range of about 80 mole percent (mol %) to about 99.5 mol %, and a paramethylstyrene content in the range of about 0.5 mol % to about 20 mol %.

Element A10: Further comprising manufacturing a rubber product using the blended isobutylene-co-paramethylstyrene composition.

Element A11: Further comprising manufacturing a rubber product using the blended isobutylene-co-paramethylstyrene composition, and wherein the rubber product is selected from the group consisting of a tire innerliner, a tire inner tube, a tire bladder, a tire sidewall, a rubber stopper, and any combination thereof.

Each of Elements A1 through A11 may be combined in any combination, without limitation.

Nonlimiting example embodiment B may include one or more of the following elements:

Element B1: Wherein the blended molecular weight distribution of the blended isobutylene-co-paramethylstyrene composition is in the range of about 2.5 to about 5.0.

Element B2: Wherein the first isobutylene-co-paramethylstyrene composition has a first molecular weight distribution and the second isobutylene-co-paramethylstyrene composition has a second molecular weight distribution, and wherein one or both of the first molecular weight distribution and the second molecular weight distribution are less than the blended molecular weight distribution.

Element B3: Wherein a ratio of the first isobutylene-co-paramethylstyrene composition to the second isobutylene-co-paramethylstyrene composition to produce the blended isobutylene-co-paramethylstyrene composition is in the range of 10:90 to 90:10.

Element B4: Further comprising halogenating the blended isobutylene-co-paramethylstyrene composition.

Element B5: Further comprising halogenating the blended isobutylene-co-paramethylstyrene composition, and wherein the halogenating comprises brominating.

Element B6: Wherein the blended isobutylene-co-paramethylstyrene composition comprises an isobutylene content in the range of about 80 mole percent (mol %) to about 99.5 mol %, and a paramethylstyrene content in the range of about 0.5 mol % to about 20 mol %.

Element B7: Further comprising manufacturing a rubber product using the blended isobutylene-co-paramethylstyrene composition.

Element B8: Further comprising manufacturing a rubber product using the blended isobutylene-co-paramethylstyrene composition, and wherein the rubber product is selected from the group consisting of a tire innerliner, a tire inner tube, a tire bladder, a tire sidewall, a rubber stopper, and any combination thereof.

Each of Elements B1 through B8 may be combined in any combination, without limitation.

Nonlimiting example embodiment C may include one or more of the following elements:

Element C1: Wherein the first reactor has a first feed flow for the first polymerization medium and the second reactor has a second feed flow for the second polymerization medium, and wherein the first feed flow and the second feed flow are independently controllable.

Element C2: Further comprising storing one or both of the first polymerization medium and the second polymerization in a storage tank, wherein the first monomers of paramethylstyrene and the second monomers of paramethylstyrene have same or different concentrations in the first polymerization reactor and the second polymerization reactor, or the storage tank.

Element C3: Wherein the blended molecular weight distribution of the blended isobutylene-co-paramethylstyrene composition is in the range of about 2.5 to about 5.0.

Element C4: Wherein the first isobutylene-co-paramethylstyrene composition has a first molecular weight distribution and the second isobutylene-co-paramethylstyrene composition has a second molecular weight distribution, and wherein one or both of the first molecular weight distribution and the second molecular weight distribution are less than the blended molecular weight distribution.

Element C5: Wherein a ratio of the first isobutylene-co-paramethylstyrene composition to the second isobutylene-co-paramethylstyrene composition to produce the blended isobutylene-co-paramethylstyrene composition is in the range of 10:90 to 90:10.

Element C6: Further comprising halogenating the blended isobutylene-co-paramethylstyrene composition.

Element C7: Further comprising brominating the blended isobutylene-co-paramethylstyrene composition.

Element C8: Wherein the blended isobutylene-co-paramethylstyrene composition comprises an isobutylene content in the range of about 80 mole percent (mol %) to about 99.5 mol %, and a paramethylstyrene content in the range of about 0.5 mol % to about 20 mol %.

Element C9: Further comprising manufacturing a rubber product using the blended isobutylene-co-paramethylstyrene composition.

Each of Elements C1 through C9 may be combined in any combination, without limitation.

To facilitate a better understanding of the embodiments of the present invention, the following examples of preferred or representative embodiments are given. In no way should the following examples be read to limit, or to define, the scope of the invention.

### Examples

In the following nonlimiting Examples, four (4) separate isobutylene-co-paramethylstyrene (referred to in the Examples hereinafter as “IMS”)-named Polymer A, Polymer B, Polymer C, and Polymer D-composed of isobutylene and paramethylstyrene (referred to in the Examples hereinafter as “pMS”) monomers, and polymerized in a reactor using a Lewis acid, initiator, and diluent. Before describing the particular methodologies, the general compositional parameters of each of Polymers A-C will be described. As shown, certain polymers are combined having the same or different concentration of paramethylstyrene monomers in a storage tank or may otherwise have the same or different concentration of paramethylstyrene monomers during polymerization.

### Example Polymer A

Polymer A was prepared according to the methodologies described hereinabove. The catalyst system and monomer feed rates were adjusted to achieve an initiator concentration within the polymerization reactor in the range of about 1.5 ppm to about 3.0 ppm. The resultant Polymer A comprises pMS content of about 5 weight % (wt %), a Mooney viscosity of about 65 MU, and a MWD of about 2.5. The average molecular weight (Mw) of Polymer A was in the range of about 200,000 to about 2,000,000. Prepared Polymer A was stored in a storage tank.

The Mooney viscosity process conditions of Polymer A are provided in Table 1 below. Samples were approximately 1 hour apart. The term “Rx” means reaction.

TABLE 1

| | | | HCl | |
|---|---|---|---|---|
| | Mooney | | Concentration | |
| | Viscosity | EADC:HCl | in Reactor | |
| Sample No. | (MU) | Ratio | (ppm) | Rx Conversion |
| A-1 | 67 | 1:1 to 10:1 | 1.5-3.0 | 87 |
| A-2 | 67 | 1:1 to 10:1 | 1.5-3.0 | 85 |
| A-3 | 65 | 1:1 to 10:1 | 1.5-3.0 | 89 |
| A-4 | 69 | 1:1 to 10:1 | 1.5-3.0 | 93 |
| A-5 | 67 | 1:1 to 10:1 | 1.5-3.0 | 94 |
| A-6 | 67 | 1:1 to 10:1 | 1.5-3.0 | 95 |

### Example Polymer B

Polymer B was prepared according to the methodologies described hereinabove. The catalyst system and monomer feed rates were adjusted to achieve an initiator concentration within the polymerization reactor in the range of about 4.0 ppm to about 8.0 ppm. The resultant Polymer B comprises pMS content of about 5 wt %, a Mooney viscosity of about 30 MU, and a MWD of about 2.5. The average molecular weight (Mw) of Polymer B was in the range of about 200,000 to about 2,000,000. Prepared Polymer B was stored in a storage tank.

The Mooney viscosity process conditions of Polymer Bare provided in Table 2 below. Samples were approximately 1 hour apart.

TABLE 2

| | | | HCl | |
|---|---|---|---|---|
| | Mooney | | Concentration | |
| | Viscosity | EADC:HCl | in Reactor | |
| Sample No. | (MU) | Ratio | (ppm) | Rx Conversion |
| B-1 | 27 | 1:1 to 10:1 | 4.0-8.0 | 98 |
| B-2 | 25 | 1:1 to 10:1 | 4.0-8.0 | 98 |
| B-3 | 25 | 1:1 to 10:1 | 4.0-8.0 | 99 |
| B-4 | 26 | 1:1 to 10:1 | 4.0-8.0 | 99 |
| B-5 | 28 | 1:1 to 10:1 | 4.0-8.0 | 99 |
| B-6 | 28 | 1:1 to 10:1 | 4.0-8.0 | 98 |
| B-7 | 26 | 1:1 to 10:1 | 4.0-8.0 | 98 |
| B-8 | 25 | 1:1 to 10:1 | 4.0-8.0 | 99 |
| B-9 | 25 | 1:1 to 10:1 | 4.0-8.0 | 99 |
| B-10 | 24 | 1:1 to 10:1 | 4.0-8.0 | 99 |
| B-11 | 25 | 1:1 to 10:1 | 4.0-8.0 | 98 |

### Example Polymer C_{b}

Polymer C_{b} is a brominated combination of Polymer A and Polymer B in a ratio of about 20:80. Each of Polymer A and Polymer B were produced separately and the resultant polymerization slurries were mixed in a mixing drum, followed by storage. It is to be understood that to mix Polymer A and Polymer B, they may be produced (polymerized in a reactor) separately (and with independent feed flow for each reactor) and stored in separate storage tanks prior to mixing, or may be produced in parallel and immediately combined in a mixing drum prior to placement in a storage tank, or may be mixed and not placed in a storage tank, but immediately to produce Polymer C_{b} upon bromination, without departing from the scope of the present disclosure. That is, the resultant mixture of Polymer A and Polymer B was brominated according to the methodologies described hereinabove to produce Polymer C_{b}.

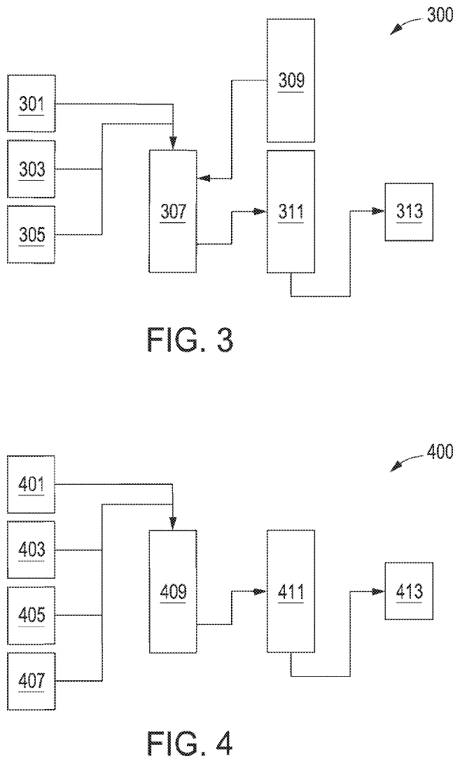

FIGS. 3 and 4 illustrate the described blending schemes 300 and 400, respectively. Referring first to FIG. 3, reactors 301, 303, and 305 each produce Polymer B and are mixed in a mixing drum 307 with Polymer A from storage tank (e.g., cement storage) 309. Thereafter, the blended combination of Polymer A and Polymer B may be stored in storage tank 311 for a duration of time. The combined mixture of Polymer A and Polymer B is then brominated 313 to produce Polymer C_{b}. Generally, the number of reactors making Polymer A and Polymer B is determined by the desired blend ratio; for example a 25:75 blend will require one reactor making polymer A and three reactors making polymer B; for another example a 75:25 blend will require three reactors making polymer A and one reactor making polymer B. The monomer feed rates to each reactor can be varied for more precise control of the blend ratio. Alternatively, and now referring to FIG. 4, reactor 401 produces Polymer A and reactors 403, 405, and 407 produce Polymer B. Each of the contents of reactors 401, 403, 405, and 407 are mixed in mixing drum 409 and may be stored in storage tank 411. The combined mixture of Polymer A and Polymer B is then brominated 413 to produce Polymer C_{b}.

### Example Polymer D

Polymer D was prepared according to the methodologies described hereinabove. The resultant Polymer D comprises pMS content of about 10 wt %, a Mooney viscosity of about 35 MU, and a MWD of about 2.5. The average molecular weight (Mw) of Polymer D was in the range of about 200,000 to about 2,000,000. Prepared Polymer D was stored in a storage tank.

### Example Blending Methodologies for Broadening MWD of Polymers A, B, and C_{b}

In this Example, Polymers A, B, C_{b} were combined in certain ratios to examine the effects of MWD using gel permeation chromatography (GPC) testing. Polymer A and Polymer B were further tested alone as controls. The GPC testing polymers are shown in Table 3 below.

TABLE 3

| Polymers for GPC Testing | Blend Ratio (%) |
|---|---|
| Polymer A | 100 |
| Polymer B | 100 |
| Polymer C_{b} (B:A) | 78:22 |
| Polymer B:Polymer A | 80:20 |
| Polymer B:Polymer A | 60:40 |
| Polymer B:Polymer A | 50:50 |
| Polymer B:Polymer A | 40:60 |
| Polymer B:Polymer A | 20:80 |

The result of the GPC testing for Polymer A and Polymer B, and blends thereof, is provided in Table 4 below.

TABLE 4

| | | Mn | Mw | Mz | |
|---|---|---|---|---|---|
| Polymers | Blend | (kDa) | (kDa) | (kDa) | Mw/Mn |
| Polymer A | 100 | 454.1 | 1299.4 | 2320 | 2.86 |
| Polymer B | 100 | 181 | 402 | 688.1 | 2.22 |
| Polymer B:Polymer A | 80:20 | 213.1 | 614.4 | 1537.8 | 2.88 |
| Polymer B:Polymer A | 60:40 | 237.8 | 807.9 | 1949.3 | 3.40 |
| Polymer B:Polymer A | 50:50 | 276.7 | 912.8 | 2075.5 | 3.30 |
| Polymer B:Polymer A | 40:60 | 262.5 | 984.1 | 2142 | 3.75 |
| Polymer B:Polymer A | 20:80 | 380.6 | 1150.3 | 2260.1 | 3.02 |

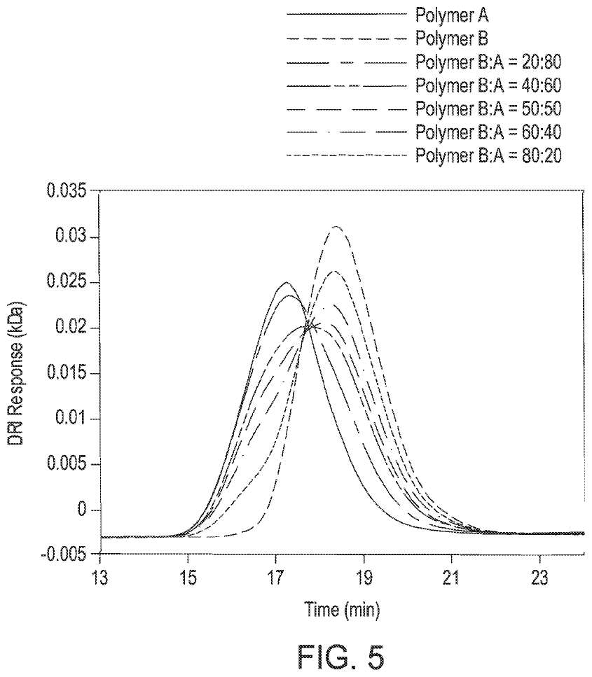

As shown in Table 4, each of the blended Polymer A and Polymer B combinations have a broader MWD compared to Polymer A or Polymer B alone. Moreover, it is to be appreciated that commercially available isobutylene-co-paramethylstyrene polymers typically have an MWD of less than 2.3, such as in the range of 2.0 to 2.3. Accordingly, this Example demonstrates that blending according to the methodologies described herein can broaden the resultant MWD. A graphical depiction of the results of Table 4 are provided in FIG. 5.

The result of the GPC testing for Polymer C_{b} (Polymer B to Polymer A of 78:22, then brominated), is provided in Table 5 below.

TABLE 5

| | | Mn | Mw | Mz | |
|---|---|---|---|---|---|
| Polymers | Blend | (kDa) | (kDa) | (kDa) | Mw/Mn |
| Polymer C_{b} | 78 (B):22 (A) | 150.8 | 527.3 | 1058.3 | 3.5 |

As shown in Table 5, the MWD has further broadened with bromination compared to the Polymer B:Polymer A blend of 80:20 provided in Table 4. Accordingly, halogenation, and particularly bromination, can be further utilized to broaden MWD according to the various aspects of the present disclosure.

### Example Blending Methodologies for Broadening MWD of Polymers A and D

In this Example, Polymers A and D were combined in certain ratios to examine the effects of MWD using GPC testing. Polymers A and D were further tested alone as controls. The GPC testing polymers are shown in Table 6 below.

TABLE 6

| Polymers for GPC Testing | Blend Ratio (%) |
|---|---|
| Polymer A | 100 |
| Polymer D | 100 |
| Polymer D:Polymer A | 10:90 |
| Polymer D:Polymer A | 20:80 |
| Polymer D:Polymer A | 30:70 |
| Polymer D:Polymer A | 40:60 |
| Polymer D:Polymer A | 50:50 |
| Polymer D:Polymer A | 60:40 |
| Polymer D:Polymer A | 70:30 |
| Polymer D:Polymer A | 80:20 |
| Polymer D:Polymer A | 90:10 |

The result of the GPC testing for Polymer A and Polymer D, and blends thereof, is provided in Table 7 below.

TABLE 7

| | | Mn | Mw | Mz | |
|---|---|---|---|---|---|
| Polymers | Blend | (kDa) | (kDa) | (kDa) | Mw/Mn |
| Polymer A | 100 | 546.3 | 1265.2 | 2335.6 | 2.3 |
| Polymer D | 100 | 182.3 | 376.4 | 632.0 | 2.1 |
| Polymer D:Polymer A | 10:90 | 459.6 | 1191.8 | 2298.2 | 2.6 |
| Polymer D:Polymer A | 20:80 | 390.9 | 1136.2 | 2308.7 | 2.9 |
| Polymer D:Polymer A | 30:70 | 330.1 | 1045.1 | 2213.3 | 3.2 |
| Polymer D:Polymer A | 40:60 | 303.4 | 964.7 | 2147.3 | 3.2 |
| Polymer D:Polymer A | 50:50 | 266.3 | 885.5 | 2128.9 | 3.3 |
| Polymer D:Polymer A | 60:40 | 247.8 | 782.7 | 1978.5 | 3.2 |
| Polymer D:Polymer A | 70:30 | 236.1 | 690.5 | 1809.8 | 2.9 |
| Polymer D:Polymer A | 80:20 | 210.8 | 601.3 | 1645.3 | 2.9 |
| Polymer D:Polymer A | 90:10 | 196.2 | 491.0 | 1271.5 | 2.5 |

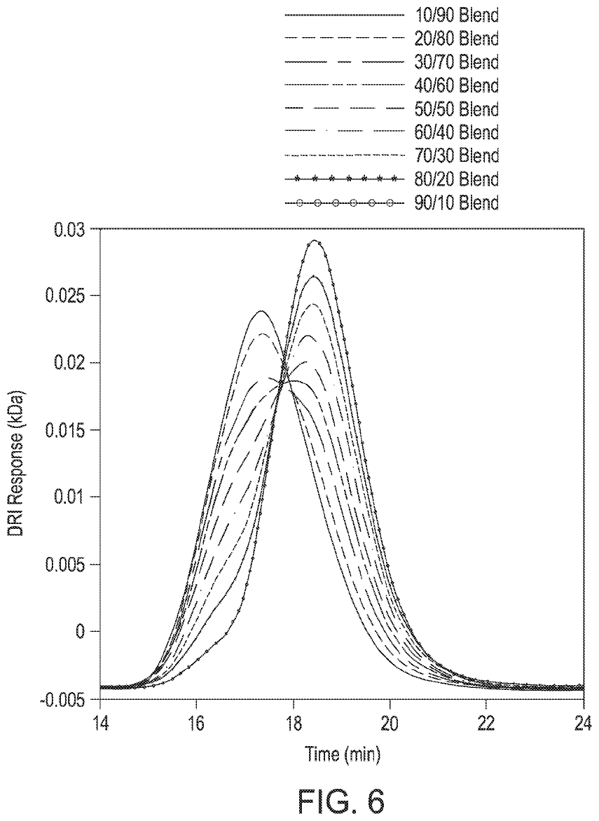

As shown in Table 4, each of the blended Polymer A and Polymer D combinations have a broader MWD compared to Polymer A or Polymer D alone, as well as commercially available isobutylene-co-paramethyl styrene polymers (MWD less than 2.3). Accordingly, this Example additionally demonstrates that blending according to the methodologies described herein can broaden the resultant MWD. A graphical depiction of the results of Table 7 are provided in FIG. 6.

Therefore, the present disclosure demonstrates that post-polymerization controls and modifications of a polymerization system according to one or more methodologies of the present disclosure can be used to broaden the molecular weight distribution of the resultant polymers.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps. Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A method comprising:
blending at least a first isobutylene-co-paramethylstyrene composition and a second isobutylene-co-paramethylstyrene composition, thereby producing a blended isobutylene-co-paramethylstyrene composition,
wherein the blended isobutylene-co-paramethylstyrene composition has a blended molecular weight distribution of equal to or greater than about 2.5.

2. The method of claim 1, wherein the blended molecular weight distribution of the blended isobutylene-co-paramethylstyrene composition is in the range of about 2.5 to about 5.0.

3. The method of claim 1, wherein the blended molecular weight distribution of the blended isobutylene-co-paramethylstyrene composition is in the range of 2.6 to 3.75.

4. The method of claim 1, wherein the first isobutylene-co-paramethylstyrene composition has a first molecular weight distribution and the second isobutylene-co-paramethylstyrene composition has a second molecular weight distribution, and wherein one or both of the first molecular weight distribution and the second molecular weight distribution are less than the blended molecular weight distribution.

5. The method of claim 4, wherein the first molecular weight distribution and the second molecular weight distribution are the same or different.

6. The method of claim 1, wherein a ratio of the first isobutylene-co-paramethylstyrene composition to the second isobutylene-co-paramethylstyrene composition to produce the blended isobutylene-co-paramethylstyrene composition is in the range of 10:90 to 90:10.

7. The method of claim 1, further comprising halogenating the blended isobutylene-co-paramethylstyrene composition.

8. The method of claim 7, wherein the halogenating is a radical halogenating process.

9. The method of claim 7, wherein the halogenating comprises brominating.

10. The method of claim 1, wherein the blended isobutylene-co-paramethylstyrene composition comprises an isobutylene content in the range of about 80 mole percent (mol %) to about 99.5 mol %, and a paramethylstyrene content in the range of about 0.5 mol % to about 20 mol %.

11. The method of claim 1, further comprising manufacturing a rubber product using the blended isobutylene-co-paramethylstyrene composition.

12. The method of claim 11, wherein the rubber product is selected from the group consisting of a tire innerliner, a tire inner tube, a tire bladder, a tire sidewall, a rubber stopper, and any combination thereof.

13. A method comprising:
polymerizing a first polymerization medium in a reactor, the first polymerization medium comprising first monomers of isobuylene, first monomers of paramethylstyrene, a first diluent, and a first catalyst system, wherein the first catalyst system comprises a first Lewis acid and a first initiator, thereby producing a first isobutylene-co-paramethylstyrene composition;
polymerizing a second polymerization medium in a reactor, the second polymerization medium comprising second monomers of isobuylene, second monomers of paramethylstyrene, a second diluent, and a second catalyst system, wherein the second catalyst system comprising a second Lewis acid and a second initiator, thereby producing a second isobutylene-co-paramethylstyrene composition; and
blending the first isobutylene-co-paramethylstyrene composition and the second isobutylene-co-paramethylstyrene composition, thereby producing a blended isobutylene-co-paramethylstyrene composition;
wherein the blended isobutylene-co-paramethylstyrene composition has a blended molecular weight distribution of equal to or greater than about 2.5.

14. The method of claim 13, wherein the blended molecular weight distribution of the blended isobutylene-co-paramethylstyrene composition is in the range of about 2.5 to about 5.0.

15. The method of claim 13, wherein the first isobutylene-co-paramethylstyrene composition has a first molecular weight distribution and the second isobutylene-co-paramethylstyrene composition has a second molecular weight distribution, and wherein one or both of the first molecular weight distribution and the second molecular weight distribution are less that the blended molecular weight distribution.

16. The method of claim 13, wherein a ratio of the first isobutylene-co-paramethylstyrene composition to the second isobutylene-co-paramethylstyrene composition to produce the blended isobutylene-co-paramethylstyrene composition is in the range of 10:90 to 90:10.

17. The method of claim 13, further comprising halogenating the blended isobutylene-co-paramethylstyrene composition.

18. The method of claim 18, wherein the halogenating comprises brominating.

19. The method of claim 13, wherein the blended isobutylene-co-paramethylstyrene composition comprises an isobutylene content in the range of about 80 mole percent (mol %) to about 99.5 mol %, and a paramethylstyrene content in the range of about 0.5 mol % to about 20 mol %.

20. The method of claim 13, further comprising manufacturing a rubber product using the blended isobutylene-co-paramethylstyrene composition.

21. A method comprising:
polymerizing a first polymerization medium in a first reactor, the first polymerization medium comprising first monomers of isobuylene, first monomers of paramethylstyrene, a first diluent, and a first catalyst system, wherein the first catalyst system comprises a first Lewis acid and a first initiator, thereby producing a first isobutylene-co-paramethylstyrene composition;
polymerizing a second polymerization medium in a second reactor, the second polymerization medium comprising second monomers of isobuylene, second monomers of paramethylstyrene, a second diluent, and a second catalyst system, wherein the second catalyst system comprising a second Lewis acid and a second initiator, thereby producing a second isobutylene-co-paramethylstyrene composition;
wherein the first reactor and the second reactor are separate, and the polymerizing the first polymerization medium and polymerizing the second polymerization medium is performed in separately in parallel; and
blending the first isobutylene-co-paramethylstyrene composition and the second isobutylene-co-paramethylstyrene composition, thereby producing a blended isobutylene-co-paramethylstyrene composition,
wherein the blended isobutylene-co-paramethylstyrene composition has a blended molecular weight distribution of equal to or greater than about 2.5.

22. The method of claim 1, wherein the first reactor has a first feed flow for the first polymerization medium and the second reactor has a second feed flow for the second polymerization medium, and wherein the first feed flow and the second feed flow are independently controllable.

23. The method of claim 1, further comprising storing one or both of the first polymerization medium and the second polymerization in a storage tank, wherein the first monomers of paramethylstyrene and the second monomers of paramethylstyrene have same or different concentrations in the first polymerization reactor and the second polymerization reactor, or the storage tank.
